(19) United States
(12) Patent Application Publication
(10) Pub. No.: US 2018/0099431 A1
(43) Pub. Date: Apr. 12, 2018

(54) TUNNEL FURNACE FOR CONTINUOUSLY HEATING PRESSED MAT

(71) Applicant: Siempelkamp Maschinen- und Anlagenbau GmbH, Krefeld (DE)

(72) Inventor: Klaus GARTZ, Viersen (DE)

(21) Appl. No.: 15/730,104

(22) Filed: Oct. 11, 2017

(30) Foreign Application Priority Data
Oct. 12, 2016 (DE) 102016119463.8

(51) Int. Cl. B27N 3/18; H05B 6/70; H05B 6/78; F26B 3/347

(52) U.S. Cl. CPC B27N 3/18; F26B 3/347; H05B 6/784; H05B 6/708

(57) ABSTRACT

A tunnel furnace for continuously heating a pressed mat for making wood-based panels has a housing forming a tunnel and a conveyor for passing the pressed mat in a travel direction through the tunnel. A microwave generator for producing microwaves is connected to a waveguide extending from the generator and forming a slot antenna having a plurality of antenna slots opening into the tunnel for irradiating the mat therein with microwaves produced by the generator.

### FIELD OF THE INVENTION

The present invention relates to tunnel furnace for continuously heating a pressed mat. More particularly this invention concerns a method of using such a furnace.

### BACKGROUND OF THE INVENTION

The invention relates to a tunnel furnace for continuously heating a pressed material mat, particularly during the manufacture of wood-based panels, with a tunnel-forming housing through whose interior space the pressed mat can pass, and with one or more microwave generators for producing microwaves that can be irradiated via one or more waveguides into the interior of the housing.

In the context of the invention, the term “pressed mat” preferably refers to a mat or web made of (glued) particles, such as chips or fibers, preferably of wood, for the manufacture of wood-based panels. The particles, such as wood chips or wood fibers, for example, are generally scattered onto a mesh belt conveyor or the like to form a mat that is subsequently passed through a continuously operating dual-belt press, for example, in which the mat is compacted under the application of pressure and/or heat into a (wood-based) panel or panel strand.

To optimize the pressing process, the pressed material or the pressed mat is preheated, particularly, in the context of the invention, with the aid of a preheater that is a continuous furnace. The pressed mat is hence preheated with the aid of microwave radiation. According to the invention, “microwave radiation” refers to electromagnetic radiation in a frequency range from 100 MHZ to 300 GHz, preferably 300 MHZ to 100 GHz. This microwave radiation is generated in one or more microwave generators, for example magnetrons, and irradiated and/or fed via waveguides into the interior of the housing.

A continuous furnace for the continuous preheating of a pressed mat of the type mentioned at the outset is known, for example, from U.S. Pat. No. 8,540,924. Microwaves in a frequency range from 2400 to 2500 MHZ are used to heat the pressed mat, with the microwaves being generated for each side of the pressed surface by 20 to 300 microwave generators with magnetrons having an output of 3 to 50 KW. The inlet and outlet of the continuous furnace are adjustable in terms of height and/or width. Movable absorption elements such as absorbent stones and/or water containers, for example, can be provided to change the dimension of the furnace inlet and/or outlet.

U.S. Pat. No. 5,369,250 describes an apparatus and a method for making products from wood or wood fibers in which microwaves are used to preheat a binding agent. Veneered woods are to be manufactured in particular.

German utility model DE 20 2015 102 422 1 describes an apparatus for continuously heating materials made of substantially nonmetallic material. It has a continuous furnace for continuously heating material on an endlessly circulating conveyor belt, the furnace having a plurality of magnetrons for generating electromagnetic waves and waveguides with outlet openings for feeding the waves into a radiation chamber. For at least two outlet openings arranged in and/or transverse to the production direction as the nearest neighbor, the main axes of the outlet openings form an angle of greater than 0° and/or the line joining the foci of the surfaces of the outlet openings form an angle of greater than 0° relative to a perpendicular of the production direction. This measure is intended to ensure the uniform heating of the material.

In addition, a microwave heater is known from US 2009/0302031 that is designed particularly for ceramic materials and molded parts and has several microwave generators for irradiating microwaves at a frequency from 300 MHZ to 5.8 GHz. inputting the high- and low-frequency microwaves is done by several coupling elements recessed into the ceiling and floor of the drying chamber. These are slot antennas tuned to the output frequency. In order to achieve an especially uniform microwave distribution, several field guides are provided in the ceiling of the drying chamber.

The focus of the invention lies in the industrial drying of ceramic materials and mineral insulation materials. These considerations have not had any influence on the design of preheaters for the wood-based panel industry.

### OBJECTS OF THE INVENTION

It is therefore an object of the present invention to provide an improved tunnel furnace for continuously heating a pressed mat.

Another object is the provision of such an improved tunnel furnace for continuously heating a pressed mat that overcomes the above-given disadvantages, in particular for the manufacture of wood-based panels so they can be heated and/or preheated in an efficient and economical manner.

### SUMMARY OF THE INVENTION

A tunnel furnace for continuously heating a pressed mat for making wood-based panels has a housing forming a tunnel and a conveyor for passing the pressed mat in a travel direction through the tunnel. A microwave generator for producing microwaves is connected to a waveguide extending from the generator and forming a slot antenna having a plurality of antenna slots opening into the tunnel for irradiating the mat therein with microwaves produced by the generator.

Here, a “slot antenna” refers to a portion of the waveguide relative to the longitudinal direction and, consequently, to a longitudinal portion of the waveguide. A waveguide, as is fundamentally known, is a conduit for electromagnetic waves (microwaves in this case). The waveguide is formed as a metal tube with a preferably rectangular (optionally also circular or elliptical) cross section.

In the prior art, such waveguides are used for conducting the microwaves in the furnace generated in the microwave generator when the microwave generators are not connected directly to the housing. In the prior art, the microwaves generally emerge from the ends of the waveguides that are open on the front side and are irradiated into the interior of the furnace. The invention, in contrast, proposes that the waveguides are formed (at least in part) as slot antennas each having a plurality of outlet slots. Preferably, the waveguide or its slot antenna is sealed with a front wall at the end, particularly at the end that faces away from the microwave generator. As a result, the microwaves do not emerge from the waveguide on the front side, but rather they are irradiated over a longitudinal wall, the so-called antenna wall, of the slot antenna, particularly through the outlet slots arranged there. Consequently, the microwaves enter the waveguide or its slot antenna on the end at the microwave generator and are reflected on the opposite closed end or the front wall, so that a standing wave is formed at the so-called waveguide wavelength within the waveguide's slot antenna, that is, two antinodes are formed for each waveguide wavelength. The field produced in this way is strongly disrupted by the slots in the antenna wall and, as a result of this disruption, the field emerges from the waveguide's slot antenna and propagates therefrom into the space, i.e. into the interior of the furnace.

According to the invention, during conventional irradiation over the waveguide that is open on the front side, reflections occur when the microwaves enter the interior of the furnace housing and the radiation enters the interior nondirectionally, thus resulting in uneven heating. The waveguide's slot antenna is used to achieve the directional irradiation of the pressed mat. Thus the inputted quantity of energy is directed to the pressed mat, and reflections are prevented. The “illumination” of the pressed mat is improved. Such slot antennas are inherently known from communications technology and are used in radio engineering to address certain sectors of a service area in a uniform and targeted manner. The invention translates such considerations to the area of the microwave heating of pressed mats for the wood-products industry. Preferably, the waveguide's slot antennas (each) have a rectangular cross section. The waveguide's slot antenna extends along a longitudinal direction, so that the waveguide's slot antenna forms a predetermined longitudinal portion of the waveguide, with this slot antenna section having an antenna wall that extends along the longitudinal direction of the antenna in which the outlet slots are arranged. The waveguide can thus also have a (conventional) waveguide section without slots. Starting from the microwave generator, the waveguide can thus has a waveguide section without slots and a slot antenna section adjacent thereto with slots. The waveguide (with waveguide section and antenna section) can extend straight in one direction and with a substantially identical cross section. However, it also lies within the scope of the invention for the waveguide section or a waveguide section to extend in a different direction than the slot antenna section, so that a spatial deflection can occur within the waveguide. This is advantageous particularly if the arrangement of the microwave generators in space so requires.

In a preferred embodiment, the waveguide's slot antennas (i.e. the antenna sections of the waveguide) project into the interior of the housing, that is, they penetrate through the housing wall. The waveguides thus do not end upon entering the housing, but extend through the housing wall and project as slot antennas into the housing, so that they are arranged above and/or below the pressed mat and (directionally) irradiate the pressed mat in a targeted manner from above and/or from below.

In an alternative embodiment, the waveguide's slot antennas can be connected on the outside to the housing or placed on the outside of the housing, so that the antenna wall is formed by a region of the housing or housing wall and/or the antenna wall forms a portion of the housing wall.

In one embodiment of the invention, the waveguide's slot antennas (or the antenna section of the waveguides) extend transverse to the direction of traverse, that is, they are arranged transverse to the longitudinal direction of the furnace. The longitudinal direction of the waveguide's slot antenna thus extends transverse or perpendicular to the throughput or travel direction of the furnace. In such an embodiment, it is advantageous if several slot antennas are arranged successively.

Alternatively, it lies within the scope of the invention for the waveguide's slot antennas to be arranged not transverse to the travel direction, but parallel to the travel direction and thus parallel to the longitudinal direction of the furnace, so that the waveguide's slot antennas extend with their longitudinal direction parallel to the travel direction. In such an embodiment, it is advantageous if several slot antennas are arranged next to one another transverse to the travel direction, so that, here too, the irradiation of the pressed mat occurs with several slot antennas.

The waveguide itself, and particularly the slot antennas thereof, preferably have a rectangular cross section, with the width defined by the antenna wall (that has the slots) preferably being 1.5 or 2.5 times, especially preferably 2 times the height of a slot antenna.

The slot antenna, for example the antenna wall thereof, preferably has at least two rows of slots that are spaced apart and extend parallel to one another, with each row of slots preferably having several slots that are arranged successively in intervals. The two rows of slots are preferably offset and thus spaced from the center line of the slot antenna or the antenna wall. Moreover, the individual slots of the two rows of slots along the longitudinal direction are preferably arranged so as to staggered. Reference is made in this regard to the description of the figures.

The individual slots are preferably rectangular. They can have for example a length from 100 mm to 200 mm.

All things considered, depending on the furnace geometry and the mat geometry, a wide range of possibilities exist in the context of the invention for adapting and configuring the slot antennas in terms of waveguide geometry and slot geometry, particularly in consideration of the respective microwave wavelength. With the aid of simulations, optimization can be performed, so that, above all, reflections upon entry into the interior of the furnace are prevented and a uniform, targeted illumination of the pressed mat (for example from above and/or from below) occurs.

The object of the invention is also a method for preheating a pressed mat, particularly during the manufacture of wood-based panels, with a continuous furnace of the described type. This method is characterized in that the pressed mat is passed through the interior of the housing and irradiated with the microwaves emerging from the slot antennas and thereby heated. Therefore, the use of such a continuous furnace for the preheating of (glued) wood-based mats during the manufacture of wood-based panels therefore has special significance according to the invention. The device is thus preferably formed as a wood-based panel heater or preheater. The continuous furnace itself can have a rectangular cross section, for example, so that the pressed mat passes at a predetermined height through the rectangular interior. As described previously, the slot antennas can project transversely to the travel direction into the interior or be placed onto the interior, so that the pressed mat is irradiated from above, for example. Alternatively, the slot antennas can also extend parallel to the travel direction within the interior or be placed onto the interior or onto the housing. In that case, the antenna wall that is provided with the slots forms a part of the upper housing wall, for example, in which the waveguide's slot antenna engages directly against the upper housing wall. The irradiation can occur from above into the upper side of the mat and/or from below onto the underside of the mat.

Alternatively, the tunnel-shaped housing can also have an oval-shaped cross section and a width, for example, that is larger than the height. The described options exist in such a case as well. In the case of such an oval-shaped, for example elliptical housing, if the slot antennas are disposed on the outside of the housing, it is possible for the waveguide's slot antennas to conform to the oval shape of the housing and thus be themselves curved along the longitudinal direction.

The tunnel-shaped housing generally has not only a housing cover (with a rectangular or oval-shaped cross section, for example), but also a front wall on the inlet side and a front wall on the outlet side that close off the furnace on the inlet and outlet side. Since the material web to be heated is to be passed continuously through the continuous furnace, the front wall on the inlet side and/or the front wall on the outlet side have an inlet-side opening on the one hand and an outlet-side opening on the other hand through which the traveling material web can enter and exit the housing. In order to prevent or reduce losses in the vicinity of these openings, it is advantageous to connect an inlet tunnel and an outlet tunnel to the inlet-side opening and/or to the outlet-side opening, respectively, with such an inlet tunnel and/or outlet tunnel generally having a substantially smaller cross section and/or a substantially smaller cross-sectional surface area than the continuous furnace itself or the housing thereof, so that the microwave losses through the inlet tunnel and the outlet tunnel are kept small. The inlet tunnel and the outlet tunnel are generally structurally designed like waveguides that are made of an electrically conductive material (for example metal), with these tunnels being dimensioned with respect to width and height such that no or minimal propagation of the microwaves of the specific wavelength occurs as soon as that they have a “destructive” effect, as it were, in that the oscillation modes of the microwaves are suppressed.

### BRIEF DESCRIPTION OF THE DRAWING

The above and other objects, features, and advantages will become more readily apparent from the following description, reference being made to the accompanying drawing in which:

FIG. 1 is a simplified side schematic view of an apparatus for making wood-based panels with a continuous furnace;

FIG. 2 is a schematic perspective view of just the tunnel furnace of FIG. 1;

FIG. 3 is a large-scale view of a detail of a slot antenna near the pressed mat to be heated;

FIG. 4 is a schematic top view of the slot wall of a slot antenna;

FIG. 5 is a modified version of the structure of FIG. 3;

FIG. 6 is a block diagram illustrating operation of the furnace of this invention; and

FIG. 7 is another view of a detail of a modified embodiment of an inventive continuous furnace.

### SPECIFIC DESCRIPTION OF THE INVENTION

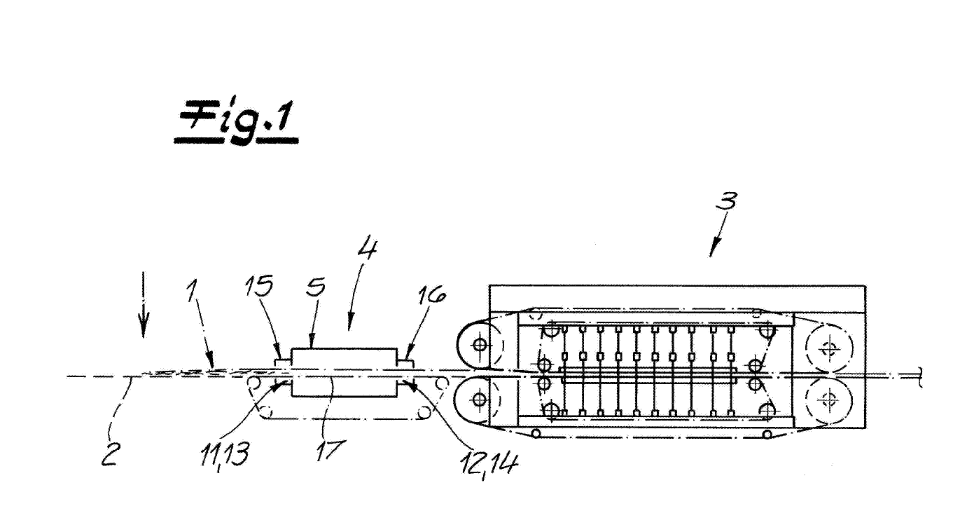

FIG. 1 shows a simplified view of a system for making wood-based panels in a continuous cycle. First, loose fibrous and/or particulate material, typically of wood, to be pressed is deposited from a supply onto the upper reach of a normally mesh belt conveyor 2 to form a loose mat 1. This loose mat 1 manufactured in this manner is pressed into a wood-based panel (for example particle board or fiber panel) in a continuously operating press 3 under application of pressure and heat. Such a press 3 is generally formed as a dual-belt press having a heated upper platen and a heated lower platen as well as endlessly circulating press belts (for example of steel) in the upper and lower parts of the press. These press belts are supported on the press platens via roller element assemblies (for example wooden bars). One or both of the heating platens is engaged by cylinders supported on the press frame to press the platens together.

In order to optimize the pressing process within the press 3, the pressed mat 1 is preheated according to the invention with the aid of a continuous tunnel furnace 4 shown only schematically in FIG. 1. For preheating, the pressed web 1 thus passes through the continuous furnace 4 that has a tunnel-shaped housing 5. In addition, the continuous furnace 4 has a plurality of microwave generators 6 so that the web 1 is exposed to microwaves in an interior 7 of the housing 5 and thereby heated. The microwave generators 6 can be magnetrons, or the generators can have such magnetrons. The microwave generators 6 are connected by waveguides 8 to the housing 5 so that the microwaves are conducted and radiated via the waveguides 8 into the interior 7 of the housing.

The tunnel-shaped housing 5 has a parallelepipedal housing 10 that has an upstream and inlet-forming wall 11 and a downstream outlet-forming wall 12. The wall 11 forms a rectangular inlet opening 13 and the wall 12 forms a similarly rectangular outlet opening 14 through which the pressed mat 1 enters and exits the housing 5. Here, in order to prevent or reduce leakage of microwaves from the interior of the housing, an inlet tunnel extension 15 is connected to the inlet opening 13 and an outlet tunnel extension 16 is connected to the outlet opening 14. For this purpose, the inlet tunnel 15 and the outlet tunnel 16 can be formed like waveguides, for example as rectangular tubes, but dimensioned such that the microwave radiation used inside the housing 5 is suppressed.

The pressed mat 1 can pass through the continuous furnace 4 on the belt 2 so that it can pass through the microwave furnace 4 without problems during operation. It also lies within the scope of the invention to provide a separate, endlessly circulating forming belt 17 for the continuous furnace, so that the pressed mat 1 previously scattered onto a first forming belt 2 is subsequently transferred to a second forming belt 17 that passes through the continuous furnace 4. According to the invention, the waveguides 8 are formed at least partially as slot antennas 8a that each have a plurality of outlet slots 9 for projecting the microwaves into the furnace interior 7.

The waveguides 8, in an inherently known manner, have a section to which a slot antenna section is then connected, thus forming the slot antenna 8a. With respect to the longitudinal direction of the waveguide 8, the slot antenna 8a is therefore a part or portion of the waveguide 8 that defines the slot antenna section 8a of the waveguide 8, with the slot antenna 8a formed by the waveguide having a length L, and with the outlet slots 9 being arranged in this longitudinal portion with the length L. The outlet slots 9 are arranged in a wall, specifically in the antenna wall 18. Here, the waveguides or slot antennas 8a are of rectangular cross section, with the antenna wall 18 with the outlet slots 9 (and opposing wall thereof) having a larger width B than the walls that extend transversely thereto and that have a width or height H. The width B of the slot antenna (as well as of the waveguides) is here approximately 2 times the height H. The front wall 19 closes off the end of the slot antenna 8a at the end of the waveguide 8 that is opposite the microwave generator 6. In this way, a standing wave is formed in the waveguide 8 and particularly in the slot antenna 8a whose field is disrupted by the slots 9 formed in the antenna wall 18, so that the microwaves enter the interior of the furnace directionally via the slots 9 and heat the pressed mat 1.

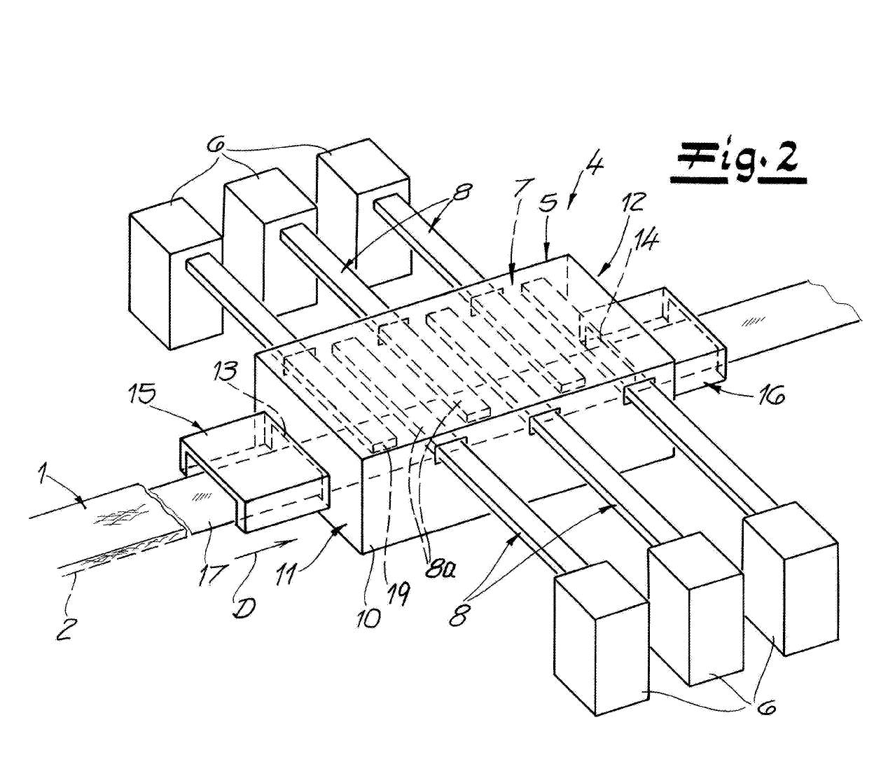

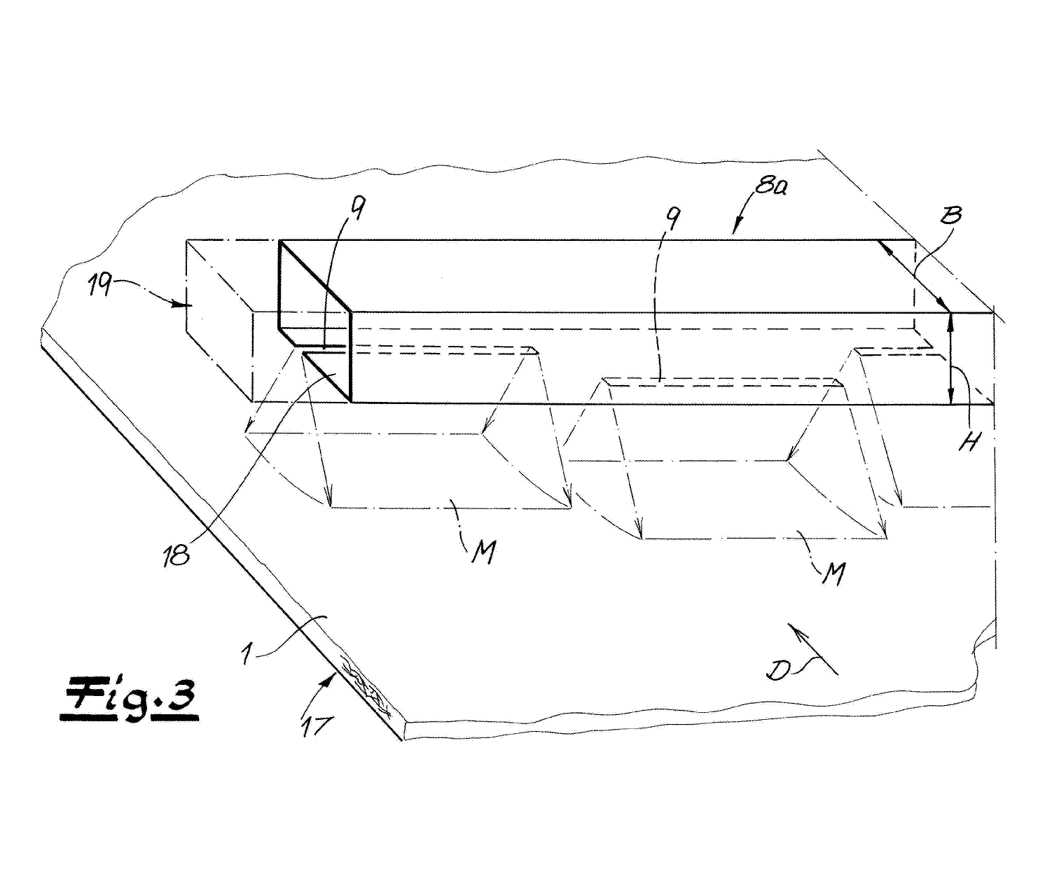

In FIG. 2, the slot antennas 8a formed as sections of the waveguides 8 project into the interior 7 of the housing 5 through the housing wall 10. The waveguides 8 thus project with their antenna section that forms the slot antennas by a predetermined amount, for example by the length L of the slot antenna, into the interior of the housing. In the embodiment of FIG. 2, the slot antennas 8a extend transverse to the travel direction D that defines the longitudinal process or travel direction through the furnace. Several slot antennas 8a that extend transverse to the travel direction are arranged successively along the travel direction D. A single one of these slot antennas is shown in FIG. 3. The microwave field M is radiated directionally out of the outlet slots onto the pressed mat 1.

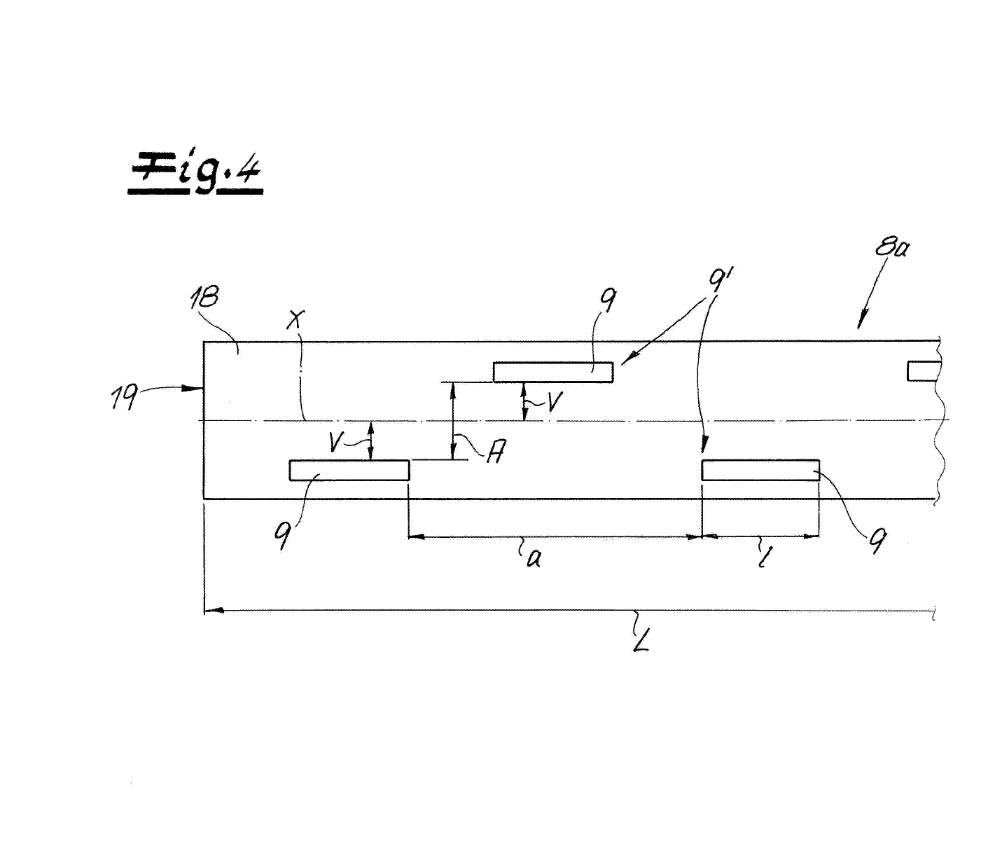

The slots 9 in the antenna wall 18 of the slot antenna 8a are shown in FIG. 4 where the slot antenna 8a, more particularly the antenna wall 18 thereof, has (at least) two rows of slots 9 running parallel to one another, each having several slots 9 that are arranged successively at spacings. The two rows of slots 9 are set at a transverse spacing A from one another, and the individual slots 9 of a row of slots 9 are staggered at a distance a from one another. The slots 9 of the two rows 9 are offset from one another along the longitudinal direction of the waveguide. It can also be seen that the two rows of slots 9 are offset relative to a centerline X of the antenna wall 18, i.e. they have a spacing V of offset from the center line X. The slots 9 themselves are rectangular with a length 1.

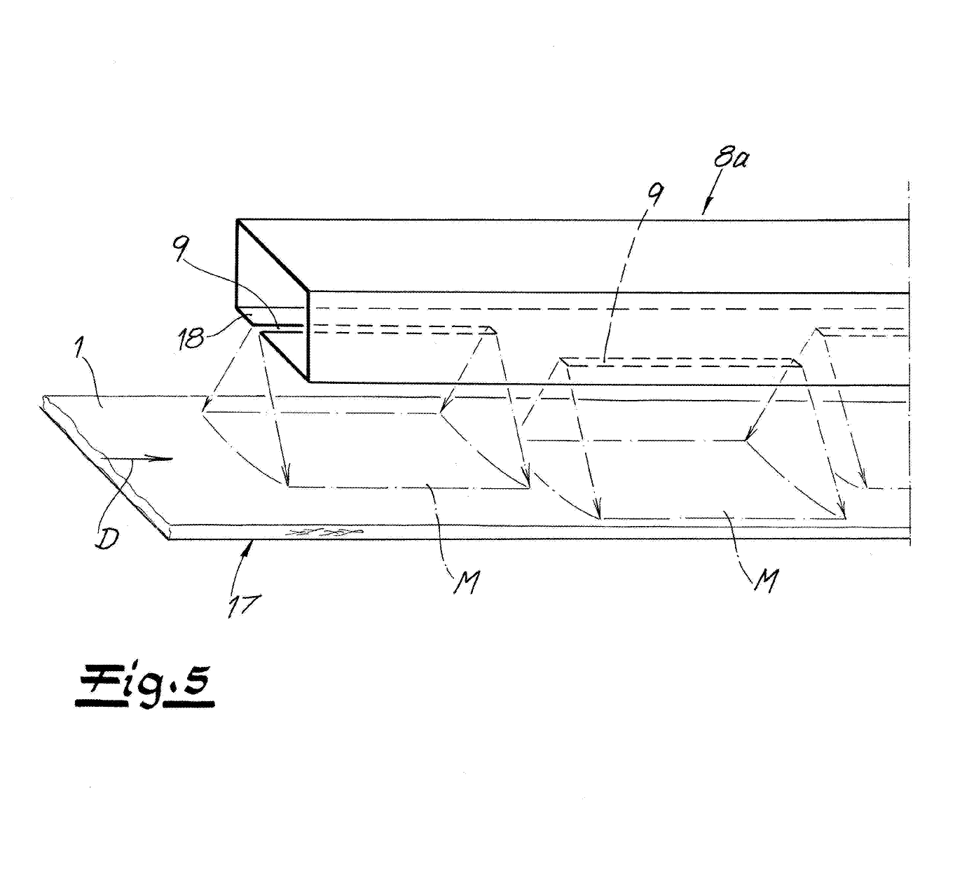

FIG. 5 shows a simplified view of a modified embodiment of the invention in which the slot antennas 8a are arranged so as to not be transverse to, but rather parallel to the travel direction D, so that they extend along the travel direction D. Here as well, it is possible for several slot antennas 8a to project out, in which case they are preferably arranged next to one another transverse to the travel direction. This is not shown in FIG. 5.

In the preferred embodiment of FIGS. 2 to 5, the slot antennas 8a project through the housing cover 10 into the interior 7 of the housing 5, so that the slot antennas 8a have an antenna housing that is separate from the housing 5.

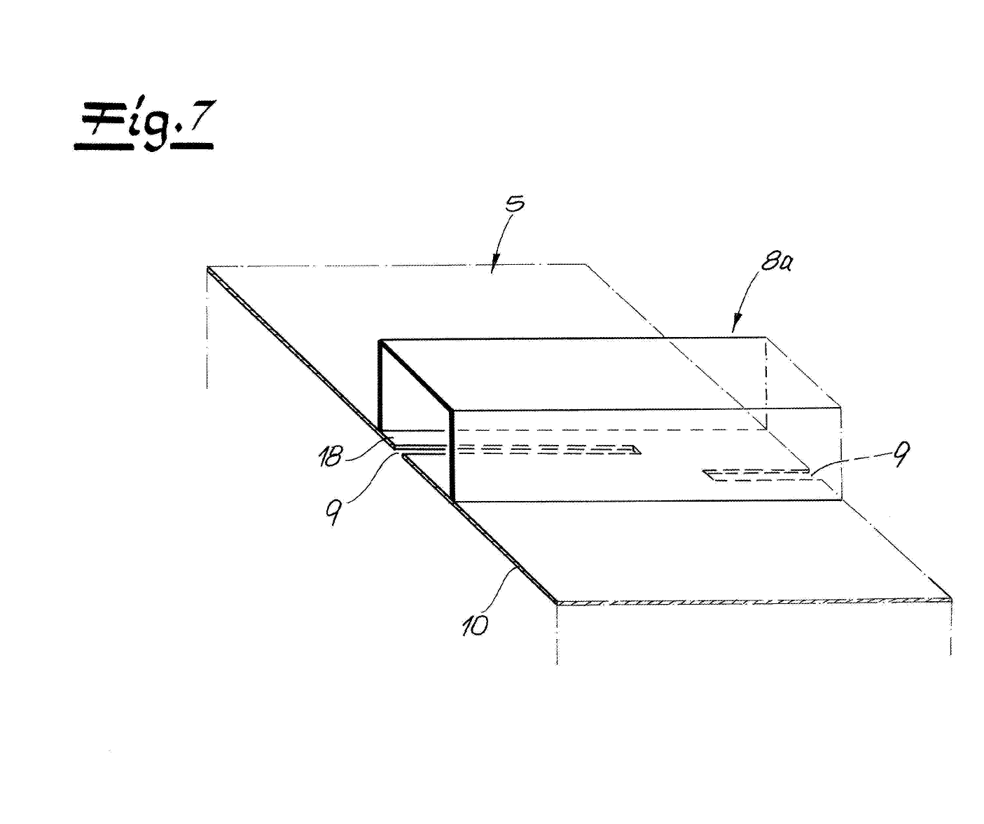

FIG. 7 shows a simplified view of a modified embodiment in which the slot antenna 8a is connected on the outside to the housing 5, so that the antenna wall 18 is formed by a region of the housing 5 or of the housing cover 10 and the antenna wall itself forms part of the housing or of the housing cover. In this embodiment, the slots 8 are in the housing jacket or cover 10. This can be achieved, for example, by placing a rectangularly U-shaped piece of sheet metal against or on the housing 5, 10, so that, together with the housing wall, a waveguide having a rectangular cross section is formed, and the slots 9 are then formed by the housing wall. Such an embodiment can also be implemented in the case of a housing 5 that does not have a rectangular cross section, but rather an oval cross section, for example, in which case the slot antenna is then curved and can be adapted to the outer periphery of the oval-shaped housing. This is not shown in the figures.

Incidentally, FIG. 2 shows that six microwave generators are provided with six waveguides, so that six slot antennas thus project into the housing. Each microwave generator can produce an output of 100 kW. The pressed mat 1 can enter the furnace at a temperature from 20° C. to 40° C., for example 35° C., and be preheated to a temperature from 70° C. to 100° C., for example 80° to 90° C.

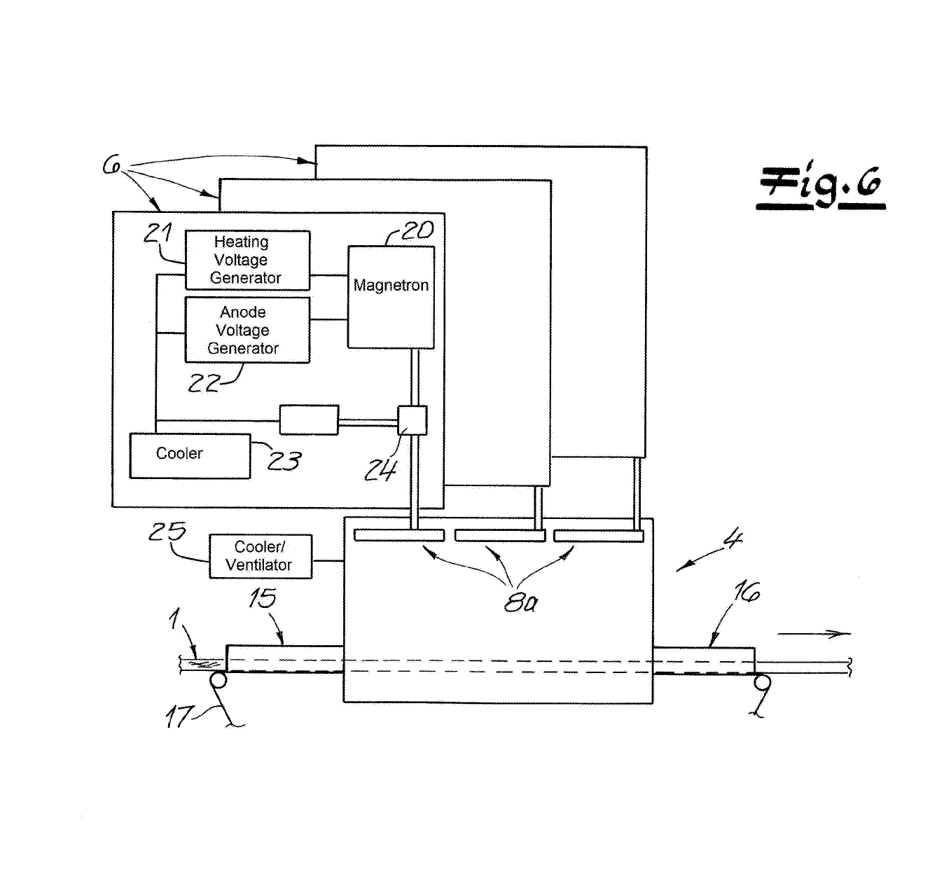

FIG. 6 shows a schematically simplified illustration of the generation of the microwaves and the coupling thereof. Every single microwave generator 6 has a magnetron 20 and a heating voltage generator 21 as well as an anode voltage generator 22 and a cooler 23 and a insulator 24. In addition, a cooler and/or ventilator 25 for the furnace is also indicated.

In this embodiment, the irradiation occurs only from above, that is, the slot antennas are arranged above the mat. Alternatively or in addition, however, slot antennas with which the mat is irradiated from below can also be under the mat.

I claim:

1. A tunnel furnace for continuously heating a pressed mat, the furnace comprising:
a housing forming a tunnel;
conveyor means for passing the pressed mat in a travel direction through the tunnel;
a microwave generator for producing microwaves; and
a waveguide extending from the generator and forming a slot antenna having a plurality of antenna slots opening into the tunnel for irradiating the mat therein with microwaves produced by the generator.

2. The tunnel furnace defined in claim 1, wherein the antenna slots each have at least one antenna wall in which the outlet slots are arranged.

3. The tunnel furnace defined in claim 1, wherein each of the waveguides is basically tubular and has an intake end connected to the respective generator and an output end provided with a cover, the slots being between the ends.

4. The tunnel furnace defined in claim 1, wherein the slot antennas project into an interior of the housing.

5. The tunnel furnace defined in claim 1, wherein the housing forma a side wall of each of the waveguides.

6. The tunnel furnace defined in claim 1, wherein each of the antenna slots extends transverse to the travel direction.

7. The tunnel furnace defined in claim 1, wherein the antenna slots extend parallel to the travel direction.

8. The tunnel furnace defined in claim 1, wherein the waveguides and the slot antennas are spaced from one another in the travel direction.

9. The tunnel furnace defined in claim 1, wherein the waveguide is of substantially rectangular cross section with a width measured horizontally equal to between 1.5 and 2.5 times a height measured vertically of the waveguide.

10. The tunnel furnace defined in claim 1, wherein the waveguide has two parallel rows of the antenna slots, the slots of each row being staggered relative to the slot of an adjacent row.

11. The tunnel furnace defined in claim 10, wherein the slots are offset with to a center line of the waveguide.

12. The tunnel furnace defined in claim 1, wherein the slots have a length from 100 mm to 200 mm.

13. A method for preheating a pressed mat with a continuous furnace as defined in claim 1, wherein:
the pressed mat is passed through the interior of the housing and irradiated with the microwaves emerging from the slot antennas and thereby heated.
